(19) United States
(12) Patent Application Publication
(10) Pub. No.: US 2021/0359304 A1
(43) Pub. Date: Nov. 18, 2021

(54) POSITIVE ELECTRODE ACTIVE MATERIAL FOR ELECTROCHEMICAL DEVICE, POSITIVE ELECTRODE FOR ELECTROCHEMICAL DEVICE, ELECTROCHEMICAL DEVICE, AND METHOD FOR MANUFACTURING POSITIVE ELECTRODE ACTIVE MATERIAL FOR ELECTROCHEMICAL DEVICE

(71) Applicant: Panasonic Intellectual Property Management Co., Ltd., Osaka (JP)

(72) Inventors: Hiroki HAYASHI, Kyoto (JP); Nao MATSUMURA, Osaka (JP); Yasuyuki ITO, Osaka (JP); Susumu NOMOTO, Kyoto (JP); Makoto AKUTSU, Osaka (JP); Tougo ENDOU, Osaka (JP)

(21) Appl. No.: 17/390,797

(22) Filed: Jul. 30, 2021

Related U.S. Application Data
(62) Division of application No. 16/037,011, filed on Jul. 17, 2018.
Application No. 16/037,011 is a continuation of application No. PCT/JP2017/001882, filed on Jan. 20, 2017.

(30) Foreign Application Priority Data
Jan. 29, 2016 (JP) 2016-016686

(51) Int. Cl. H01M 4/583; H01G 11/86; H01M 4/1399; H01G 11/06; H01G 11/48; H01M 4/36; H01M 4/60; H01G 11/24; H01M 50/44; H01M 50/531; H01M 50/429; H01M 4/04; H01M 4/137; H01M 4/1393; H01M 4/66; H01M 10/0525

(52) U.S. Cl. CPC H01M 4/583; H01G 11/28; H01M 4/1399; H01G 11/06; H01G 11/48; H01M 4/364; H01M 4/606; H01G 11/24; H01M 4/608; H01M 50/44; H01M 50/531; H01M 50/4295; H01M 4/0466; H01M 4/137; H01M 4/1393; H01M 4/661; H01M 10/0525; H01G 11/86

(57) ABSTRACT

A positive electrode active material for an electrochemical device has a fiber shape or a grain-aggregate shape. The positive electrode active material includes an inner core part having a fiber shape or a grain-aggregate shape, and a superficial part covering at least part of the inner core part. The inner core part contains a first conductive polymer, and the superficial part contains a second conductive polymer that is different from the first conductive polymer.

### RELATED APPLICATIONS

This application is a divisional of U.S. application Ser. No. 16/037,011 filed on Jul. 17, 2018, which is a continuation of the PCT International Application No. PCT/JP2017/001882 filed on Jan. 20, 2017, which claims the benefit of foreign priority of Japanese patent application No. 2016-016686 filed on Jan. 29, 2016, the contents all of which are incorporated herein by reference.

### TECHNICAL FIELD

The present disclosure relates to an electrochemical device including a positive electrode containing a conductive polymer.

### BACKGROUND

In recent years, an electrochemical device having an intermediate property between the lithium ion secondary battery and the electric double layer capacitor attracts attention. For example, utilization of a conductive polymer as a positive electrode material for the electrochemical device has been considered (see Unexamined Japanese Patent Publication No. 2014-35836). Since a positive electrode containing a conductive polymer allows the Faraday reaction to proceed along with the adsorption (doping) and the desorption (dedoping) of anion, the positive electrode has a small reaction resistance and brings higher output of the electrochemical device compared with a positive electrode generally used in a lithium ion secondary battery.

As a conductive polymer, polyaniline, polypyrrole and the like are known, and there has been proposed to use a combination of polyaniline and polypyrrole to realize a positive electrode having both characteristics of polyaniline and polypyrrole. For example, polyaniline is regarded as a promising candidate for a positive electrode material because polyaniline has relatively large capacity density. However, polyaniline disadvantageously shows a large voltage drop at the time of large current discharge. By combining polyaniline and polypyrrole, the voltage drop in the positive electrode is suppressed (See Unexamined Japanese Patent Publication No. H1-146255).

### SUMMARY

First aspect of the present disclosure relates to a positive electrode active material for an electrochemical device. The positive electrode active material includes an inner core part having a fiber shape or a grain-aggregate shape, and a superficial part covering at least part of the inner core part. The inner core part contains a first conductive polymer, and the superficial part contains a second conductive polymer that is different from the first conductive polymer. And the positive electrode active material has a fiber shape or a grain aggregate shape.

Second aspect of the present disclosure relates to a positive electrode for an electrochemical device. The positive electrode includes a positive current collector, and a positive electrode material layer supported on the positive current collector. The positive electrode material layer contains the above positive electrode active material.

Third aspect of the present disclosure relates to an electrochemical device. The electrochemical device includes the above positive electrode, a negative electrode having a negative electrode material layer that stores and releases lithium ions, and a nonaqueous electrolytic solution having lithium ionic conductivity.

Fourth aspect of the present disclosure relates to a method for manufacturing a positive electrode active material for an electrochemical device. The method includes the steps of forming an inner core part having a fiber shape or a grain-aggregate shape in a first solution, the inner core part containing a first conductive polymer; and forming a superficial part covering at least part of the inner core part in a second solution so as to form a positive electrode active material having a fiber shape or a grain-aggregate shape. The first solution and the second solution respectively contain polymerizable compounds that are different from each other. And the superficial part contains a second conductive polymer that is different from the first conductive polymer.

According to the present disclosure, when a combination of a plurality of conductive polymers is used as a positive electrode active material contained in the positive electrode material layer of the electrochemical device, it is possible to impart the characteristic of one of the conductive polymers while suppressing reduction of the effective surface area of the other of the conductive polymers. Therefore, it is possible to obtain an electrochemical device having excellent characteristic balance.

### BRIEF DESCRIPTION OF DRAWINGS

FIG. 1 is a schematic sectional view illustrating an electrochemical device according to an exemplary embodiment of the present disclosure.

FIG. 2 is a view for illustrating a configuration of the electrochemical device according to the exemplary embodiment.

FIG. 3 is a conceptual view illustrating a positive electrode active material having a multilayer structure including an inner core part of a fiber shape.

FIG. 4 is a picture of a scanning electron microscope which shows an inner core part formed of fibrously grown polyaniline.

### DESCRIPTION OF EMBODIMENTS

Prior to describing an exemplary embodiment of the present disclosure, a problem found in conventional techniques will be briefly described.

The conductive polymer is formed in various shapes depending on the synthetic conditions. Therefore, when a plurality of conductive polymers are used in combination, it is difficult to control the respective microstructures of conductive polymers. Hence, the effective surface area of the positive electrode is likely to decrease. As a result, it becomes difficult to sufficiently exert the respective characteristics of the plurality of conductive polymers.

A positive electrode active material for an electrochemical device according to the present disclosure includes an inner core part having a grain-aggregate shape or a fiber shape, and a superficial part covering at least part of the inner core part. The inner core part contains a first conductive polymer. The positive electrode active material also has a fiber shape or a grain-aggregate shape. The superficial part contains a second conductive polymer that is different from the first conductive polymer. Further, the positive electrode according to the present disclosure has a positive current collector, and a positive electrode material layer supported on the positive current collector. And the positive electrode material layer contains a positive electrode active material in a fiber shape or a grain-aggregate shape.

Since the positive electrode active material has a fiber shape or a grain-aggregate shape, the positive electrode material layer has a porous structure, and thus has plenty of gaps. Further, the superficial part is formed to cover at least part of the surface of the inner core part so as not to fill the gaps formed in the inner core part of a fiber shape or a grain-aggregate shape. Therefore, the effective surface area of the second conductive polymer becomes large, and the characteristic of the second conductive polymer is exhibited. Also, since the inner core part is formed of the first conductive polymer, the characteristic of the first conductive polymer is exhibited.

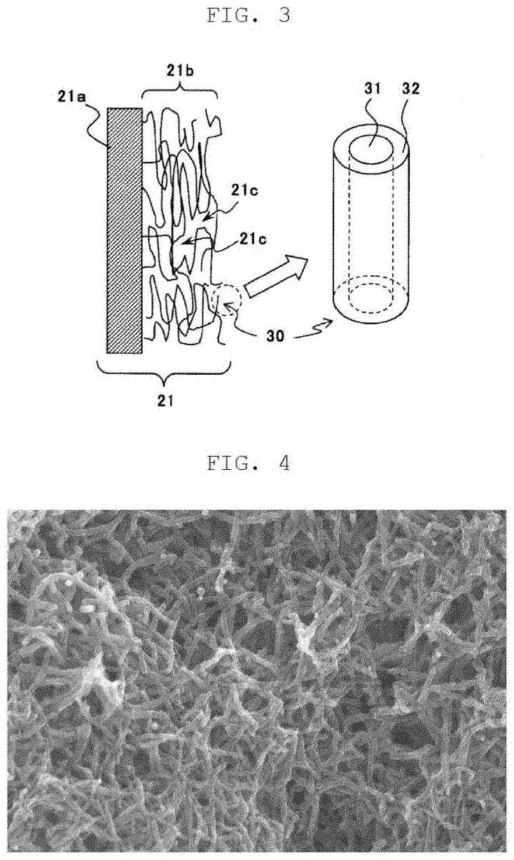

Hereinafter, structures of the positive electrode material layer, and the positive electrode active material contained inside the positive electrode material layer are described more specifically. The superficial part of the positive electrode active material is formed along the shape of the inner core part. Hence, the gaps formed in the inner core part are not filled, and are maintained. FIG. 3 conceptually illustrates one exemplary structure of the positive electrode material layer. Left part of FIG. 3 is a schematic sectional view illustrating positive electrode 21 which is cut at a plane parallel with a thickness direction of positive current collector 21a. Right part of FIG. 3 is an enlarged schematic view illustrating a multilayer structure of positive electrode active material 30 having a fiber shape. Positive electrode material layer 21b has positive electrode active material 30 having a multilayer structure, including fibrous core 31 (inner core part) formed of a first conductive polymer, and superficial part 32 that covers at least part of fibrous core 31. And superficial part 32 is formed of a second conductive polymer. That is, the shape characteristic of fibrous core 31 is maintained. Positive electrode material layer 21b contains plenty of gaps 21c inside by containing positive electrode active material 30 having a fiber shape.

It is noted that the shape of the positive electrode active material contained in the positive electrode material layer is not limited to a fiber shape, but may be a grain-aggregate shape. In this case, the positive electrode active material has a core-shell structure that includes a grain-aggregate core (inner core part) formed of a first conductive polymer, and a superficial part that covers at least part of the grain-aggregate core. And the superficial part is formed of a second conductive polymer. Thus the shape characteristic of the grain-aggregate core is maintained.

In the positive electrode active material in a fiber shape or a grain-aggregate shape, it is preferred that the inner core part has a volume larger than a volume of the superficial part. When the volume of the superficial part is reduced, and thus the superficial part is formed thinly, the shape characteristic of the inner core part is easy to be maintained. Hence, plenty of gaps are easy to be maintained in the positive electrode material layer. The relation between the volume of the inner core part and the volume of the superficial part can be determined according to a photograph of a sectional view of the positive electrode active material. For example, the sectional view of the positive electrode is photographed by a scanning electron microscopy (SEM), and then the photograph of the sectional view is binarized. The section area (Sᵢₙ) of the inner core part and the section area (Soot) of the superficial part are respectively measured, and then these section areas can be compared. At this time, Sᵢₙ preferably ranges from 1 time to 10000 times Sₒᵤₜ, and more preferably ranges from 3 times to 100 times Sₒᵤₜ. The magnitude relation between the volume of the inner core part and the volume of the superficial part can be analyzed by ESCA (Electron Spectroscopy for Chemical Analysis), ATR (Attenuated Total Reflection)/FT-IR or the like, alternatively.

A combination of the first conductive polymer and the second conductive polymer is appropriately selected depending on the required characteristic of the desired positive electrode material layer. As the first conductive polymer, a combination of a plurality of conductive polymers may be used, and as the second conductive polymer, a combination of a plurality of conductive polymers may be used. Further, the first conductive polymer may be a copolymer containing plural kinds of monomer units, and the second conductive polymer may be a copolymer containing plural kinds of monomer units. In other words, each of the inner core part and the superficial part is not needed to be formed of one conductive polymer, and it is only required that the inner core part and the superficial part have different compositions.

Kinds of the conductive polymers used as the first conductive polymer and the second conductive polymer are not particularly limited, and an organic polysulfide compound, a π-electron conjugated polymer or the like can be used.

The organic polysulfide compound is a collective term for compounds having an —S—S— bond, and examples of the organic polysulfide compound include chained or cyclic disulfide compounds, trisulfide compounds and so on. The compounds may be used alone or in combination of a plurality of compounds in the inner core part or the superficial part.

The first conductive polymer and the second conductive polymer each may contain, as a π-electron conjugated polymer, at least one of a monopolymer and a copolymer of at least one polymerizable compound selected from a group consisting of aniline, pyrrole, thiophene, furan, thiophene vinylene, pyridine and a derivative of aniline, pyrrole, thiophene, furan, thiophene vinylene, or pyridine. That is, as the π-electron conjugated polymer, a homopolymer containing monomer units derived from the aforementioned polymerizable compounds, or a copolymer containing monomer units derived from two or more of the aforementioned polymerizable compounds can be used. More specifically, polyaniline, polypyrrole, polythiophene, polyfuran, polythiophene vinylene, polypyridine, and polymer derivatives having these polymers as a basic skeleton can be obtained. The polymer derivative refers to a polymer of a derivative compound such as, for example, an aniline derivative, a pyrrole derivative, a thiophene derivative, a furan derivative, a thiophene vinylene derivative, or a pyridine derivative, and examples of the polymer derivative include poly(3,4-ethylenedioxythiophene) (PEDOT) having polythiophene as a basic skeleton. The compounds may be used alone or in combination of a plurality of compounds in the inner core part or the superficial part. A weight average molecular weight of the π-electron conjugated polymer is not particularly limited and for example, ranges from 1000 to 100000, inclusive.

The π-electron conjugated polymer exhibits excellent conductivity by doping with anion (dopant). Examples of the anion include sulfate ion, nitrate ion, phosphate ion, borate ion, benzenesulfonate ion, naphthalenesulfonate ion, toluenesulfonate ion, methanesulfonate ion (CF₃SO₃⁻), perchlorate ion (ClO₄⁻), tetrafluoroborate ion (BF₄⁻), hexafluorophosphate ion (PF₆⁻), fluorosulfate ion (FSO₃⁻), bis(fluorosulfonyl)imide ion (N(FSO₂)₂⁻), and bis(trifluoromethanesulfonyl)imide ion (N(CF₃SO₂)₂⁻). These compounds may be used alone, or two or more of the compounds may be used in combination.

The anion may be a polymer ion. Examples of the polymer ion include ions of polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid.

These polymer ions may be a homopolymer or a copolymer of two or more monomers. These polymer ions may be used alone, or may be used in combination of two or more of these polymer ions.

Next, some preferred embodiments of the positive electrode material layer are exemplified.

### First Exemplary Embodiment

A positive electrode active material contained in a positive electrode material layer according to the present exemplary embodiment has a fiber shape or a grain-aggregate shape. The positive electrode active material has an inner core part having a fiber shape or a grain-aggregate shape. The inner core part contains a first conductive polymer. And the positive electrode active material also has a superficial part covering at least part of the inner core part. The superficial part contains a second conductive polymer that is different from the first conductive polymer. The second conductive polymer has a capacity density larger than a capacity density of the first conductive polymer. As a result, the positive electrode material layer of the present exemplary embodiment is easy to bring high capacity of the electrochemical device. Since the conductive polymer allows the Faraday reaction to proceed along with the adsorption (doping) and the desorption (dedoping) of anion, it is preferred that, from the view point of obtaining high capacity, the conductive polymer having higher capacity density is disposed near the interface with the nonaqueous electrolytic solution (superficial part) where the utilization become high. Also, since the superficial part has smaller reaction resistance compared with the inner core part, it is advantageous in charging and discharging at high output.

The capacity density, which is a physical property that is generally uniquely determined according to the individual conductive polymer, means a capacity per mass (mAh/g) that capable to exhibit by the conductive polymer.

For example, by using a π-electron conjugated polymer such as polyaniline or polypyrrole as the first conductive polymer that forms the inner core part, and by using an organic polysulfide compound including 2,5-dimethylcapto-1, 3, 4-thiadiazole, 1, 3, 5-triazine-2, 4, 6-trithiol or the like as the second conductive polymer that forms the superficial part, it is possible to obtain a positive electrode for an electrochemical device having high capacity.

### Second Exemplary Embodiment

A positive electrode active material contained in a positive electrode material layer according to the present exemplary embodiment has a fiber shape or a grain-aggregate shape. The positive electrode active material has an inner core part having a fiber shape or a grain-aggregate shape. The inner core part contains a first conductive polymer. And the positive electrode active material also has a superficial part covering at least part of the inner core part. The superficial part contains a second conductive polymer that is different from the first conductive polymer. The second conductive polymer has an elastic modulus larger than an elastic modulus of the first conductive polymer. As a result, the positive electrode material layer of the present exemplary embodiment exerts excellent durability of the second conductive polymer while exerting the characteristic of the first conductive polymer. The electrostatic capacity brought by the positive electrode material layer increases with the specific surface area (surface area per unit volume) of the inner core part. And an advantage in output characteristic of the positive electrode also increases with the specific surface area of the inner core part. However, the conductive polymer that is easy to fibrillate and easy to have a larger specific surface area tends to have low strength. In such a case, it is preferred to use, as the second conductive polymer utilized in the superficial part, a conductive polymer having higher elastic modulus than the first conductive polymer utilized in the inner core part.

For example, by using polyaniline as the first conductive polymer that forms the inner core part of the positive electrode active material, and by using polypyrrole, polythiophene or the like as the second conductive polymer that forms the superficial part, it is possible to obtain a positive electrode for an electrochemical device which has large specific surface area, high capacity and excellent durability.

### Third Exemplary Embodiment

A positive electrode active material contained in a positive electrode material layer according to the present exemplary embodiment has a fiber shape or a grain-aggregate shape. The positive electrode active material has an inner core part having a fiber shape or a grain-aggregate shape. The inner core part contains a first conductive polymer. And the positive electrode active material also has a superficial part covering at least part of the inner core part. The superficial part contains a second conductive polymer that is different from the first conductive polymer. The first conductive polymer is a π-electron conjugated polymer containing a nitrogen atom, and the second conductive polymer is a π-electron conjugated polymer containing a sulfur atom.

A π-electron conjugated polymer containing a nitrogen atom is easy to form an inner core part having a large specific surface area, but tends to have lower heat resistance. When a conductive polymer having low heat resistance is used in the positive electrode material layer, deterioration in capacity proceeds in a high temperature environment. Such deterioration in capacity proceeds more easily in the superficial part than in the inner core part. On the other hand, since a π-electron conjugated polymer containing a sulfur atom has relatively high heat resistance, it is possible to suppress deterioration of the superficial part by using the π-electron conjugated polymer containing a sulfur atom as the second conductive polymer.

For example, a π-electron conjugated polymer containing a sulfur atom, e.g., polythiophene or polyethylenedioxythiophene has higher heat resistance than a π-electron conjugated polymer containing nitrogen atom, e.g., polyaniline or polypyrrole. Therefore, by using polyaniline or polypyrrole as the first conductive polymer that forms the inner core part of the positive electrode active material, and by using polythiophene or polyethylenedioxythiophene as the second conductive polymer that forms the superficial part, it is possible to obtain a positive electrode for an electrochemical device having excellent heat resistance.

Next, one example of a method for manufacturing a positive electrode active material for an electrochemical device and a positive electrode will be described. The manufacturing method, however, is not limited to the following.

A method for manufacturing a positive electrode active material includes the steps of; (i) forming an inner core part having a fiber shape or a grain-aggregate shape in a first solution, the inner core part containing a first conductive polymer; and (ii) forming a superficial part covering at least part of the inner core part in a second solution so as to form a positive electrode active material having a fiber shape or a grain-aggregate shape. The first solution and the second solution respectively contain polymerizable compounds that are different from each other. Therefore, the first conductive polymer forming the inner core part is different from the second conductive polymer forming the superficial part in kind or in composition. That is, the superficial part contains the second conductive polymer that is different from the first conductive polymer. The first solution may be brought into contact with the positive current collector, for example, by immersing the positive current collector in the first solution. As a result, an inner core part adhered to the positive current collector is formed in the first solution, and a positive electrode material layer adhered to the positive electrode active material (namely, positive electrode material layer) can be formed in the second solution. Hereinafter, the case of forming the inner core part adhered to the positive current collector is further described.

(i) Step of forming inner core part

First, the positive current collector is immersed in the first solution, and then an inner core part having a fiber shape or a grain-aggregate shape adhered to the positive current collector is formed. For example, the inner core part is formed by polymerizing a first polymerizable compound (first monomer) which is a material for the first conductive polymer. The polymerization method of the first monomer may be electrolytic polymerization or chemical polymerization, but the electrolytic polymerization is preferred from the point of controllability of the shape of the inner core part. The shape of the inner core part is controlled by a polymerization condition in the first solution, the kind of the first monomer and so on. The polymerization condition includes the temperature, the monomer concentration, and the current density in the electrolysis.

Before immersing of the positive current collector in the first solution, the surface of the positive current collector may be roughened by etching, or a conductive carbon layer may formed on the surface of the positive current collector. For example, when the positive current collector is an aluminum foil, it is preferred to form a conductive carbon layer by applying a carbon paste on the surface of the aluminum foil, and drying the carbon paste. The carbon paste can be obtained by dispersing carbon black and a resin component in water or in an organic solvent.

Thereafter, by immersing the positive current collector in the first solution, opposing the positive current collector to a counter electrode, and flowing a current between the positive current collector serving as an anode, and the counter electrode, an inner core part containing the first conductive polymer is formed so as to cover at least part of the surface of the positive current collector or the conductive carbon layer.

An inner core part containing the first conductive polymer doped with anion may be formed by using the first solution containing anion that is to be a dopant. Also, an oxidizing agent that promotes electrolytic polymerization may be added to the first solution. As a solvent of the first solution, water may be used, or an organic solvent may be used in consideration of the solubility of the first monomer. As the organic solvent, alcohols are preferred, and ethyl alcohol, methyl alcohol, isopropyl alcohol, ethylene glycol, propylene glycol or the like can be used.

It is preferred that the first solution is controlled so as to have a pH ranging from 0 to 6, inclusive, and a temperature ranging from 0° C. to 45° C., inclusive. A current density is not particularly limited, however, preferably it ranges from 0.1 mA/cm² to 100 mA/cm², inclusive. It is preferred that a first monomer concentration in the first solution ranges from 0.01 mol/L to 3 mol/L, inclusive. It is preferred that a concentration of anion that is to be a dopant in the first solution ranges from 0.01 mol/L to 3 mol/L, inclusive. After forming the inner core part, the positive current collector formed with the inner core part is taken out from the first solution, is washed to remove the unreacted first monomer, and is dried.

(ii) Step of forming superficial part

Then the dried positive current collector formed with the inner core part is immersed in the second solution so as to form a superficial part covering at least part of the inner core part. For example, the superficial part is formed by polymerizing a second polymerizable compound (second monomer) which is a material for the second conductive polymer. Here, by forming a thin superficial part along the shape of the inner core part so that the gaps formed by the inner core part sufficiently remain, a positive electrode active material in a fiber shape or a grain-aggregate shape is formed. The polymerization method of the second monomer may be electrolytic polymerization or chemical polymerization, but the electrolytic polymerization is preferred. The electrolytic polymerization allows easy control of the thickness of the superficial part by the current density in the electrolysis and the polymerization time.

The superficial part containing the second conductive polymer is formed so as to cover at least part of the surface of the inner core part by opposing the positive current collector having the inner core part to a counter electrode, and causing a current to flow between the positive current collector serving as an anode, and the counter electrode.

A superficial part containing the second conductive polymer doped with a dopant may be formed by using the second solution containing anion that is to be a dopant. Also, an oxidizing agent that promotes electrolytic polymerization may be added to the second solution. As a solvent of the second solution, water may be used, or an organic solvent may be used. Here, as the organic solvent, alcohols as described above are preferred.

It is preferred that the second solution is controlled so as to have a pH ranging from 0 to 6, inclusive, and a temperature ranging from 0° C. to 45° C., inclusive. A current density is not particularly limited, however, preferably it ranges from 0.1 mA/cm² to 100 mA/cm², inclusive. It is preferred that a second monomer concentration in the second solution ranges from 0.01 mol/L to 3 mol/L, inclusive. It is preferred that a concentration of anion that is to be a dopant in the second solution ranges from 0.01 mol/L to 3 mol/L, inclusive. At this time, by shortening the time of the electrolytic polymerization, it is possible to form a thin superficial part. The current density (I₂) in the second aqueous solution may be made smaller, in comparison with the current density (I₁) in the first solution. It is preferred that 12 is controlled in the range of 1% to 100% of I₁.

After forming the superficial part, the positive current collector having the positive electrode material layer, which includes the active layer having the inner core part and the superficial part, is taken out from the second solution, is washed to remove the unreacted second monomer, and then dried. And thus a positive electrode can be obtained.

In the positive electrode material layer obtained in the method as described above, the positive electrode active material having a fiber shape or a grain-aggregate shape is formed directly on the positive current collector (in other words, conductively connecting with the positive current collector). Hence, the respective positive electrode active materials are electrically connected to the positive current collector. Therefore, it is not necessary to contain a conducting agent such as conductive carbon so as to form a conductive path inside the positive electrode material layer.

The above description indicates the case of performing electrolytic polymerization in synthesis of each conductive polymer, but each conductive polymer may be synthesized by chemical polymerization. In the above method, the positive electrode active material is directly formed on the positive current collector, but the positive electrode material layer may be formed, for example, applying a paste on the surface of the positive current collector. The paste is prepared by generating the positive electrode active material in a solution by chemical polymerization, and then mixing the obtained positive electrode active material with a conducting agent such as conductive carbon, a binder and the like. In this case, it is preferred to mix a conducting agent so as to form a conductive path inside the positive electrode material layer. Examples of a conducting agent or a binder that can be used include the materials used in a negative electrode material layer as will be described later.

Next, an exemplary embodiment of an electrochemical device will be described.

The electrochemical device according to the present exemplary embodiment includes the aforementioned positive electrode, negative electrode, and nonaqueous electrolytic solution. If the electrochemical device is a lithium ion battery, the negative electrode includes a negative electrode material layer that stores and releases lithium ions, and the nonaqueous electrolyte has lithium ion conductivity.

Hereinafter, each constituent of the electrochemical device will be described in more detail.

(Positive Electrode)

The positive electrode has a positive electrode material layer containing a positive electrode active material where an oxidation-reduction reaction involving doping and dedoping of the anion proceeds. The positive electrode material layer is supported on a positive current collector. For example, a conductive sheet material is used for the positive current collector. As the sheet material, a metal foil, a metal porous body, a punching metal or the like is used. As a material of the positive current collector, aluminum, an aluminum alloy, nickel, titanium or the like can be used. The positive electrode material layer has a structure described above.

(Negative Electrode)

The negative electrode has a negative electrode material layer containing a negative electrode active material where an oxidation-reduction reaction involving storing and releasing of lithium ions proceeds. The negative electrode material layer is supported on a negative current collector. For example, a conductive sheet material is used for the negative current collector. As the sheet material, a metal foil, a metal porous body, a punching metal or the like is used. As a material of the negative current collector, copper, a copper alloy, nickel, stainless steel or the like can be used.

Examples of the negative electrode active material include a carbon material, a metal compound, an alloy, a ceramic material and the like. As the carbon material, graphite, non-graphitizable carbon (hard carbon), and easily graphitizable carbon (soft carbon) are preferred, and graphite and hard carbon are particularly preferred. Examples of the metal compound include silicon oxide, tin oxide and the like. Examples of the alloy include a silicon alloy, a tin alloy and the like. Examples of the ceramic material include lithium titanate, lithium manganate, and the like. These compounds may be used alone, or may be used in combination of two or more of these compounds. Among these materials, a carbon material can achieve low potential of the negative electrode, and thus is preferred.

The negative electrode material layer preferably contains a conducting agent, a binder and the like besides the negative electrode active material. Examples of the conducting agent include carbon black, carbon fibers, and the like. Examples of the binder include a fluorine resin, an acrylic resin, a rubber material, a cellulose derivative, and the like. Examples of the fluorine resin include polyvinylidene fluoride, polytetrafluoroethylene, tetrafluoroethylene-hexafluoropropylene copolymer, and the like. Examples of the acrylic resin include polyacrylic acid, acrylic acid-methacrylic acid copolymer, and the like. Examples of the rubber material include a styrene-butadiene rubber, and examples of the cellulose derivative include carboxymethyl cellulose.

The negative electrode material layer is formed, for example, by preparing a negative electrode mixture paste as a mixture of a negative electrode active material, a conducting agent, a binder and a dispersing medium, and applying the negative electrode mixture paste onto the negative current collector. For the dispersing medium, water, N-methyl-2-pyrrolidone (NMP) or the like is preferably used. Thereafter, the applied film is preferably pressed between rollers in order to enhance the strength.

The lithium ion is preferably pre-doped in the negative electrode (negative electrode active material) in advance. Thereby, a potential of the negative electrode is lowered, and therefore a difference in potential between the positive electrode and the negative electrode (that is, a voltage) is increased and energy density of the electrochemical device is improved.

Pre-doping of lithium ions in the negative electrode proceeds, for example, by forming a metal lithium film serving as a supply source of a lithium ion on the surface of the negative electrode material layer, and impregnating the negative electrode having the metal lithium film with the nonaqueous electrolytic solution having lithium ionic conductivity. In this time, the lithium ion is eluted in the nonaqueous electrolytic solution from the metal lithium film and the eluted lithium ion is stored in the negative electrode active material. For example, when graphite or hard carbon is used as the negative electrode active material, lithium ions are inserted in the interlayer of the graphite or the fine pores of the hard carbon. An amount of lithium ion to be pre-doped can be controlled by a mass of the metal lithium film.

A method of forming the metal lithium film on the surface of the negative electrode material layer may be a method of bonding a metal lithium foil to the negative electrode material layer, or may be a method of depositing a lithium film on the surface of the negative electrode material layer applying a vapor phase method. The vapor phase method is, for example, a method of using a vacuum deposition apparatus, and a thin film of metal lithium can be formed by evaporating metal lithium in an apparatus in which a degree of vacuum is enhanced and depositing the metal lithium on the surface of the negative electrode material layer.

(Nonaqueous Electrolytic Solution)

The nonaqueous electrolytic solution having lithium ionic conductivity includes a lithium salt and a nonaqueous solvent for dissolving the lithium salt. The anion contained in the lithium salt is doped or dedoped reversibly to the positive electrode in association with charging and discharging. On the other hand, the negative electrode stores and releases lithium ions derived from the lithium salt.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, LiN(CF₃SO₂)₂ and the like. These lithium salts may be used alone, or may be used in combination of two or more of these lithium compounds. A concentration of the lithium salt in the nonaqueous electrolytic solution may, for example, ranges from 0.2 mol/L to 4 mol/L, inclusive, and is not particularly limited.

Examples of the nonaqueous solvent include cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone and γ-valerolactone; chain ethers such as 1,2-dimethoxyethane (DME), 1,2-diethoxyethane (DEE) and ethoxymethoxyethane (EME); cyclic ethers such as tetrahydrofuran and 2-methyltetrahydrofuran; dimethylsulfoxide, 1,3-dioxolane, formamide, acetamide, dimethylformamide, dioxolane, acetonitrile, propionitrile, nitromethane, ethylmonoglyme, trimethoxymethane, sulfolane, methyl sulfolane, 1,3-propanesultone or the like can be used. These solvents may be used alone, or may be used in combination of two or more of these solvents.

The nonaqueous electrolytic solution may contain an additive contained in the nonaqueous solvent as necessary. For example, unsaturated carbonate such as vinylene carbonate, vinyl ethylene carbonate, and divinyl ethylene carbonate may be added as an additive for forming a coating having high lithium ionic conductivity on the surface of the negative electrode.

By laminating or winding a positive electrode and a negative electrode while a separator is interposed therebetween, a laminate type or wound type electrode group is formed. As a material of the separator, a nonwoven fabric made of cellulose fiber, a nonwoven fabric made of glass fiber, a microporous membrane made of polyolefin, a fabric cloth, a nonwoven fabric or the like is preferably used. A thickness of the separator ranges, for example, from 10 μm to 300 μm, inclusive, and preferably from 10 μm to 40 μm, inclusive.

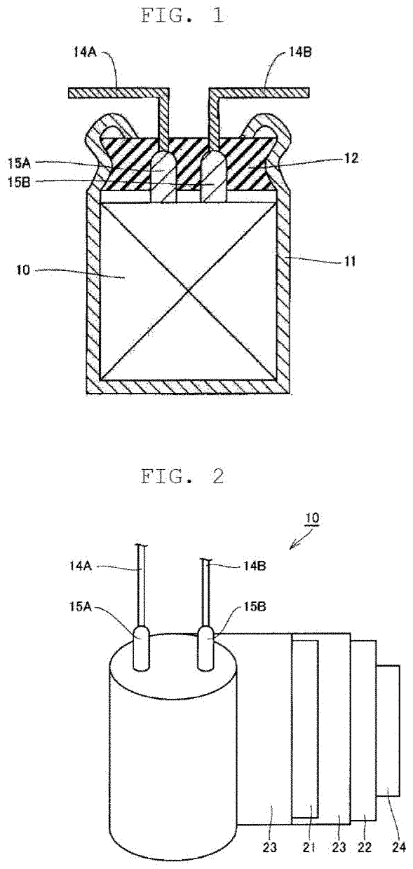

The electrode group together with the nonaqueous electrolytic solution is housed, for example, in a bottomed case having an opening. Thereafter, the opening is closed with a sealing body to complete an electrochemical device. FIG. 1 is a schematic sectional view of one example of an electrochemical device, and FIG. 2 is a schematic view of a partial development of the electrochemical device.

Electrode group 10 is a wound body as shown in FIG. 2 and includes positive electrode 21, negative electrode 22, and separator 23 interposed between positive electrode 21 and negative electrode 22. An outermost periphery of the wound body is fixed by fastening tape 24. Positive electrode 21 is connected to lead tab 15A and negative electrode 22 is connected to lead tab 15B. The electrochemical device includes electrode group 10, bottomed case 11 housing electrode group 10, sealing body 12 for closing the opening of bottomed case 11, lead wires 14A, 14B led out from sealing body 12, and the nonaqueous electrolytic solution (not shown). Lead wires 14A, 14B are connected to lead tabs 15A, 15B, respectively. Sealing body 12 is formed of, for example, an elastic material containing a rubber component. Bottomed case 11 is, at a part near an opening end, processed inward by drawing, and is, at the opening end, curled to swage body 12.

A step of pre-doping lithium ions in the negative electrode may be performed before assembling the electrode group, or pre-doping may be advanced after housing the electrode group in a case of the electrochemical device together with the nonaqueous electrolytic solution. In this case, the metal lithium film is previously formed on the surface of the negative electrode (negative electrode material layer), and then the electrode group may be prepared.

In the exemplary embodiment described above, a wound electrochemical device having a cylindrical shape has been described. The application range of the present disclosure, however, is not limited to the wound electrochemical device and can also be applied to a square or a laminate type electrochemical device.

### EXAMPLES

Hereinafter, the present disclosure will be described in more detail with reference to examples; however, the present disclosure is not to be considered to be limited to the examples.

### Example 1

(1) Preparation of Positive Electrode

An aluminum foil having a thickness of 30 μm was prepared as a positive current collector. On a surface of the aluminum foil, a conductive carbon layer having a thickness of 1.5 μm was formed. The conductive carbon layer is a mixed layer of 100 parts by mass of carbon black and 30 parts by mass of a binder.

On the other hand, as a first solution, a polymerization liquid having an aniline at concentration of 1 mol/L and a sulfuric acid at concentration of 2 mol/L was prepared. The first solution was adjusted to a pH of 0.6 and a temperature of 25° C. Then, a positive current collector having a conductive carbon layer and a stainless steel counter electrode were immersed in the first solution. And then electrolytic polymerization at a current density of 10 mA/cm² was conducted for 20 minutes to deposit an inner core part of a first conductive polymer (polyaniline) doped with sulfate ions (SO₄²⁻) entirely on the front and back surfaces the positive current collector. Then, the positive current collector having the inner core part, along with the counter electrode, was taken out from the first solution, was washed with distilled water, and was dried.

A photograph of the obtained inner core part taken by scanning electron microscope (SEM) is shown in FIG. 4. From FIG. 4, it can be understood that polyaniline has grown in a fibrous form, and has a porous structure having plenty of gaps.

Next, as a second solution, a polymerization liquid having a pyrrole at concentration of 1 mol/L and a sulfuric acid at concentration of 2 mol/L was prepared. The second solution was adjusted to a pH of 0.6 and a temperature of 25° C. Then, a positive current collector formed with the inner core part and a stainless steel counter electrode were immersed in the second solution. And then electrolytic polymerization at a current density of 1 mA/cm² was conducted for 5 minutes to make a superficial part of a second conductive polymer (polypyrrole) doped with sulfate ions (SO₄²⁻) grow on the surface of the inner core part. And thus a fibrous positive electrode active material was formed. Then the positive current collector formed with the positive electrode active material (namely, positive electrode material layer) was taken out from the second solution, was washed with distilled water, and was dried.

The positive electrode material layer is constituted by a fibrous positive electrode active material having the shape characteristic of the inner core part maintained exactly. And the positive electrode material layer had a thickness of 60 μm for each side of the positive current collector. The sectional view of the positive electrode material layer was photographed by a scanning electron microscopy (SEM), and a photograph obtained by SEM was binarized. The section area (Sᵢₙ) of the inner core part and the section area (Sₒᵤₜ) of the superficial part were respectively measured. The volume Sᵢₙ of the inner core part was calculated to 50 times the volume Sₒᵤₜ of the superficial part.

(2) Preparation of Negative Electrode

A copper foil having a thickness of 20 μm was prepared as a negative current collector. On the other hand, a carbon paste was prepared by kneading mixed powder and water at a weight ratio of 40:60. The mixed powder is a mixture of 97 parts by mass of hard carbon, 1 part by mass of carboxy cellulose, and 2 parts by mass of styrene butadiene rubber. The carbon paste was applied on both sides of the negative current collector and dried to obtain a negative electrode having a negative electrode material layer with a thickness of 35 μm on both sides. Next, a metal lithium foil was bonded to the negative electrode material layer. An amount of metal lithium foil was calculated so that a negative potential in the nonaqueous electrolytic solution after completion of pre-doping is 0.2 V or less with respect to metal lithium.

(3) Electrode Group

After a lead tab was connected to each of the positive electrode and the negative electrode, as shown in FIG. 2, a separator of a cellulose nonwoven fabric (thickness 35 μm), the positive electrode, and the negative electrode were alternately overlaid to obtain a laminate, and an electrode group was formed by winding the laminate.

(4) Nonaqueous Electrolytic Solution Vinylene carbonate of 0.2% by mass was added to a mixture of propylene carbonate and dimethyl carbonate at a volume ratio of 1:1 to prepare a nonaqueous solvent. LiPF₆ was dissolved in the resulting nonaqueous solvent at a concentration of 2 mol/L to prepare a nonaqueous electrolytic solution having hexafluorophosphate anions (PF₆⁻) as the anion to be doped and dedoped to the positive electrode.

(5) Preparation of Electrochemical Device

The electrode group and the nonaqueous electrolytic solution were housed in a bottomed case having an opening and an electrochemical device as shown in FIG. 1 was assembled. Thereafter, the electrochemical device was aged at 25° C. for 24 hours under application of a charge voltage of 3.8 V between the terminals of the positive electrode and the negative electrode, and thus pre-doping of lithium ions to the negative electrode was proceeded. In this manner, electrochemical device (A1) having a voltage across terminals of 3.2 V was completed.

### Comparative Example 1

Electrochemical device (B1) was prepared in the same manner as Example 1 except that a superficial part covering at least part of the inner core part was not formed in preparation of a positive electrode material layer (positive electrode active material).

### Comparative Example 2

Electrochemical device (B2) was prepared in the same manner as Example 1 except that a current density at the time of forming a superficial part was changed from 1 mA/cm² to 10 mA/cm² in preparation of a positive electrode material layer (positive electrode active material). After formation of the superficial part, the positive electrode material layer was observed by SEM. Gaps of the fibrous inner core part were filled with polypyrrole, and the positive electrode active material had lost the shape characteristic of the inner core part. In other words, the positive electrode material layer was formed of a dense film-like positive electrode active material.

[Evaluation]

An initial capacity (C₀) and an internal resistance (R₀) of an electrochemical device were measured. Then, the electrochemical device was stored at 70° C. for 1000 hours under application of a charge voltage of 3.5 V. A capacity (C₁) and an internal resistance (R₁) of the electrochemical device after storage were measured.

Table 1 shows results of the above evaluation.

TABLE 1

| Electrochemical device | | A1 | B1 | B2 |
|---|---|---|---|---|
| Initial | C₀(F) | 117 | 121 | 42 |
| | R₀(mΩ) | 81 | 85 | 78 |
| After storage | C₁(F) | 116 | 92 | 41 |
| | R₁(mΩ) | 86 | 228 | 81 |

Polypyrrole has a capacity density of 140 mAh/g that is slightly smaller than the capacity density of polyaniline (150 mAh/g), and polypyrrole is superior to polyaniline in heat resistance, and polypyrrole has a larger elastic modulus than polyaniline. Therefore, in Example 1, the maintenance rate of capacity after storage at 70° C. is higher, and increase in internal resistance is suppressed compared with Comparative Example 1. On the other hand, in the case of Comparative Example 2, the characteristic of the inner core part was not exerted, and the initial capacity significantly became low.

The electrochemical device according to the present disclosure can be suitably applied, for example, to the use having a higher capacity than an electric double layer capacitor or a lithium ion capacitor and requiring a higher output than a lithium ion secondary battery.

What is claimed is:

1. An electrochemical device comprising:
a positive electrode including a positive current collector and a positive electrode active material supported on the positive current collector;
a negative electrode; and
a nonaqueous electrolytic solution including an anion, wherein:
the positive electrode active material includes:
an inner core part consisting of a first conductive polymer, the first conductive polymer forming a fiber shape or a grain-aggregate shape; and
a superficial part covering at least part of the inner core part,
the superficial part contains a second conductive polymer that is different from the first conductive polymer,
the anion in the nonaqueous electrolytic solution is doped to or dedoped from both of the first conductive polymer and the second conductive polymer in accordance with charging and discharging,
an elastic modulus of the second conductive polymer is greater than an elastic modulus of the first conductive polymer, and
a volume of the inner core part is larger than a volume of the superficial part, and
the positive electrode active material has a fiber shape or a grain-aggregate shape so that the superficial part is formed along a shape of the inner core part.

2. The electrochemical device according to claim 1, wherein the superficial part surrounds the inner core part.

3. The electrochemical device according to claim 1, wherein:
the first conductive polymer includes a π-electron conjugated polymer containing a nitrogen atom, and
the second conductive polymer includes a π-electron conjugated polymer containing a sulfur atom.

4. The electrochemical device according to claim 1, wherein the second conductive polymer has a capacity density greater than a capacity density of the first conductive polymer.

5. The electrochemical device according to claim 1, wherein the first conductive polymer and the second conductive polymer each include at least one of a homopolymer or a copolymer of at least one polymerizable compound, the at least one polymerizable compound including at least one selected from a group consisting of aniline, pyrrole, thiophene, furan, thiophene vinylene, pyridine and a derivative of aniline, pyrrole, thiophene, furan, thiophene vinylene, or pyridine.

6. The electrochemical device comprising according to claim 1, wherein:
the negative electrode includes a negative electrode material layer that stores and releases lithium ions, and
the nonaqueous electrolytic solution has lithium ion conductivity.
